(19) United States
(12) Patent Application Publication
(10) Pub. No.: US 2008/0076955 A1
(43) Pub. Date: Mar. 27, 2008

(54) Method and System for Pre-Treating Fly Ash

(75) Inventors: Rafic Y. Minkara, Kennesaw, GA (US); Thomas B. Graham JR., Woodstock, GA (US); Robert D. Nelson, Stone Mountain, GA (US)

Correspondence Address: WEGMAN, HESSLER & VANDERBURG, 6055 ROCKSIDE WOODS BOULEVARD, SUITE 200, CLEVELAND, OH, 44131, US

(73) Assignee: Headwaters Incorporated, South Jordan, UT (US)

(21) Appl. No.: 11/662,034

(22) PCT Filed: Sep. 7, 2005
(86) PCT No.: PCT/US05/31820

§ 371 Date: Mar. 23, 2007

Related U.S. Application Data
(60) Provisional application No. 60/607,796, filed on Sep. 8, 2004.

(51) Int. Cl. C04B 18/08; A62D 3/00; C04B 20/02; B01D 53/58

(52) U.S. Cl. 588/313; 422/168

(57) ABSTRACT

A method and system for treating fly ash by addition of a chemical reagent during fly ash transfer operations. The method includes discharging fly ash from a fly ash storage silo and metering the mass flow rate of the fly ash being discharged with a mass flow metering device. The method also includes generating a signal from the mass flow metering device corresponding to the mass flow rate of the fly ash and adding a chemical reagent to the fly ash at a selected chemical reagent addition rate with a chemical feeding device, wherein the chemical reagent addition rate is selected based upon the mass flow rate of fly ash removal. The method also includes blending the chemical reagent with the fly ash to treat the fly ash and transferring the treated fly ash to a work or disposal location.

### CROSS REFERENCE TO RELATED APPLICATION

The present application claims priority under 35 U.S.C. §119(e) to U.S. Provisional Patent Application No. 60/607,796, filed Sep. 8, 2004 and entitled “METHOD AND PROCESS OF PRE-TREATING ASH”.

### BACKGROUND OF THE INVENTION

1. Field of Invention

This invention relates to systems and methods for the treatment of fly ash, and more specifically, to a system and method for pre-treating fly ash by adding a chemical reagent during fly ash transfer operations.

2. Description of Related Art

Coal burning power stations commonly use ammonia or ammonia based reagents in the fly ash containing flue gas to: (1) enhance electrostatic precipitator (ESP) performance to reduce opacity and (2) remove nitrous oxide (NOₓ) using selective catalytic reduction (SCR) and selective non-catalytic reduction (SNCR) technologies to meet NOₓ emission regulations. Ammonia injection in the flue gas for ESP performance enhancement commonly results in the deposition of ammonia on fly ash. Also, gas phase reaction of SO₃ and NH₃ in the flue gas results in the deposition on fly ash of ammonium salts in the forms of ammonium sulfate (NH₄)2SO₄ and ammonium bisulfate NH₄HSO₄. In both SCR and SNCR processes, NOₓ is reduced using ammonia to produce nitrogen gas and water vapor according to the following reaction:
4NO+4NH₃+O₂→4N₂+6H₂O
2NO₂+4NH₃+O₂→3N₂+6H₂O

The degree of fly ash contamination with ammonia and concentration levels vary among power plants depending on the rate of ammonia injection, the performance of SCR and SNCR processes, the amount of SO₃ in the flue gas and the operating conditions of the boiler and air pollution control devices.

Fly ash produced at coal fired power plants is commonly used in concrete applications as a pozzolanic admixture and for partial replacement for cement. Fly ash is an essential component in high performance concrete and contributes many beneficial characteristics to concrete including increased density and long term strength, decreased permeability and improved durability to chemical attack. Also, fly ash improves the workability of fresh concrete. When ammonia contaminated fly ash is used in Portland cement based mortar and concrete application, the ammonium salts dissolve in water to form NH₄⁺. Under the high pH (pH>12) condition created by cement alkali, ammonium cations (NH₄⁺) are converted to dissolved ammonia gas (NH₃). Ammonia gas evolves from the fresh mortar or concrete mix into the air exposing concrete workers.

In addition to the risk of human exposure to ammonia gas evolving from concrete produced using ammonia laden ash, the disposal of said ash in landfills and ponds at coal burning power stations could also create potential risks to human and the environment. Ammonium salt compounds in fly ash are extremely soluble. Upon contact with water, the ammonium salts leach into the water and could be carried to ground water and nearby rivers and streams causing potential environmental damage such as ground water contamination, fish kill and eutrophication. Ammonia gas could also evolve upon wetting of alkaline fly ashes, such as those generated from the combustion of western sub-bituminous coal. Water conditioning and wet disposal of alkaline fly ashes would expose power plant workers to ammonia gas.

It is known from commonly assigned U.S. Pat. No. B 6,790,264 entitled Control of Ammonia Emission from Ammonia Laden Fly Ash, which is hereby incorporated by reference in its entirety, to treat ammonia-laden fly ash with the addition of a chemical oxidizing agent. The chemical oxidizing agent does not react with ammonia in the dry fly ash; the chemical oxidizing agent is released during the wet slurry mixing process. Once the ammonia-laden fly ash is introduced in the cementitious slurry, ammonium salts from the ammonia-laden fly ash dissolve. The high alkaline (high pH) condition of the cementitious slurry converts the ammonium cations (NH₄⁺) to dissolved ammonia gas (NH₃). Without the chemical oxidizing agent, ammonia gas (NH₃) evolves from the cementitious slurry during mixing, transportation, pouring and placement.

The preferred chemical treatment reagents are strong oxidizers such as hypochlorites (OCl⁻) commonly found in the form of Ca(OCl)₂, NaOCl, LiOCl, trichloro-s-triazinetrione (trichlor), etc. and are added to the ammonia-laden fly ash. The chemical oxidizing agent is added to the dry ammonia-laden fly ash prior to incorporating the fly ash into cementitious slurries. Upon mixing the treated fly ash with the cementitious slurry, a chemical conversion occurs converting the ammonia into harmless products. The reagent is activated upon water addition and reacts with dissolved ammonia in the ash or concrete slurry to form primarily monochloramine (NH₂Cl). Thereby, the exposure risk of the ammonia gases (NH₃) is limited. An overdose of the hypochlorite reagent would further oxidize monochloramine to form nitrogen gas (NH₂) and chlorides. The basic aqueous phase ammonia oxidation reaction using hypochlorite is as follows:
NH₄⁺+OCl⁻→NH₂Cl+H₂O

The rate of ammonia oxidation by hypochlorite depends upon pH, temperature, time, initial dosage and the presence of competing reducing agents. The pH condition of this reaction in Portland cement based concrete and mortar is governed by the presence of alkali from the associated cement hydration. The expected cementitious slurry pH is between 12 and 14. The temperature of freshly mixed concrete tends to be slightly warmer than the ambient temperature as a result of the heat of hydration. The optimum concrete temperature is in the range of 10 to 15° C. (50 to 60° F.), or lower for massive concrete pours, to avoid thermal cracking. Concrete temperature should not exceed 33° C. (90° F.). Time of reaction is also governed by conventional and standard concrete practices namely mixing, handling and placing guidelines. Ready-mixed concrete batches are mixed for at least 5 to 10 minutes. ASTM C94 requires the concrete to be placed within 90 minutes of mixing. The ammonia, in ammonia-laden fly ash and concrete mixtures, represents the most readily available reducing agent to react with hypochlorite. The chloramine forming reaction of ammonia and hypochlorite in water are 99% complete within a few minutes. Theoretically, a 1:1 molar ratio of hypochlorite to ammonia (Cl:N) is needed to produce monochloramine. Further increases in the molar ratio of Cl:N result in further oxidation and formation of nitrogen gas and chloride salts.

It would be desirable to have an improved space efficient and cost effective process and system for adding the chemical reagent to the fly ash containing concentrations of ammonia.

### SUMMARY OF THE INVENTION

The invention is directed to a space efficient and cost effective method for treating dry ammoniated fly ash. In one aspect, the invention is directed to a method of treating fly ash containing ammonia by means of controlled addition and blending of a chemical reagent in a dry form with the ammonia laden fly ash. The added reagent is not activated until the subsequent water addition to the ash or concrete mix containing the ash. The method includes measuring and controlling the mass flow of the fly ash, metering an appropriate reagent dosage, blending the reagent and the fly ash in the ash measuring device, and delivering the blend into a tanker truck or other dry powder holding container.

In one aspect, the invention is directed to a system for treating fly ash by addition of a chemical reagent during fly ash transfer operations. The system includes a fly ash storage silo and a mass flow metering device for metering the mass flow rate of the fly ash being discharged from the silo. The metering device generates a signal corresponding to the mass flow rate of the fly ash. The system further includes a chemical feeding device for adding a chemical reagent to the fly ash at a selected chemical reagent addition rate. A programmable logic controller is configured to receive the signal corresponding to the mass flow rate of the fly ash and select the chemical reagent addition rate based upon said signal. The system also includes a load out spout for delivering the treated fly ash.

In another aspect, the invention is directed to a method for treating fly ash by addition of a chemical reagent during fly ash transfer operations. The method includes discharging fly ash from a fly ash storage silo and metering the mass flow rate of the fly ash being discharged with a mass flow metering device. The method also includes generating a signal from the mass flow metering device corresponding to the mass flow rate of the fly ash and adding a chemical reagent to the fly ash at a selected chemical reagent addition rate with a chemical feeding device, wherein the chemical reagent addition rate is selected based upon the mass flow rate of fly ash removal. The method also includes blending the chemical reagent with the fly ash to treat the fly ash and transferring the treated fly ash to a work or disposal location.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawing, wherein:

FIG. 1 is schematic view of a dry fly ash treatment system according to one embodiment of the invention;

FIG. 2 is schematic view of a wet fly ash treatment system according to one embodiment of the invention; and

FIG. 3 is schematic view of a programmable logic controller used with the treatment systems of FIGS. 1 and 2.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

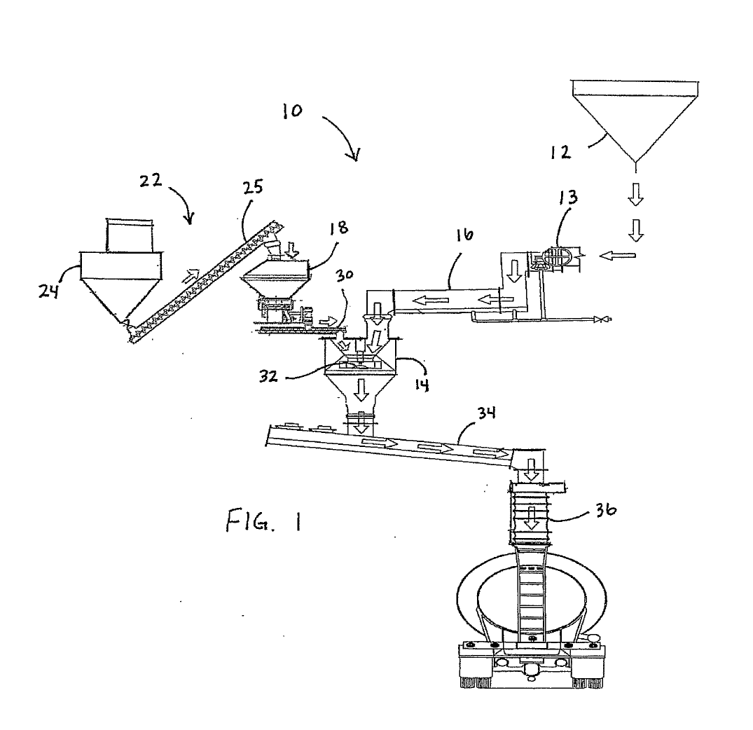

This invention relates to a system and process for the treatment of ash using chemical reagents added during ash transfer operations. Referring to FIG. 1, a dry ash treatment system 10 for blending the chemical reagent with the fly ash is schematically illustrated. The system 10 includes a fly ash storage silo 12 of the type typically found at fossil fuel burning power plants. Fly ash is typically stored in the overhead silos 12 for gravity load out into tanker trucks, rail cars and the like. According to the invention, the fly ash is treated by the continuous addition and blending of a chemical reagent with the fly ash during ash transfer operations which move the ash from the silo 12 to a work or disposal site. In one embodiment, the fly ash is treated with an oxidizing reagent to mitigate the effect of ammonia in the fly ash such as described in commonly assigned U.S. Pat. No. 6,790,264. Suitable oxidizing reagents include hypochlorites (OCl⁻) in the form of calcium hypochlorite (Ca(OCl)₂), lithium hypochlorite (LiOCl) or trichloro-s-triazinetrione (C₃N₃O₃Cl₃) to be used to treat the ammonia laden fly ash to eliminate or substantially reduce ammonia gas evolution from the high pH slurries of fly ash and concrete. Although the process and system described herein refer to the addition of an oxidizing reagent being added to ammonia-laden fly ash, one skilled in the art will understand that this invention could also be used to treat ash with any other dry or liquid chemical to improve ash quality or impart a specific product performance attribute without departing from the scope of the invention.

Desirably, the fly ash is removed from the silo 12 by gravity discharge. The rate of removal of the fly as from the silo 12 is controlled with a flow control device 13. Preferably, the flow control device 13 is an automated rotary gate valve. However, other means of controlling the gravity discharge of the fly ash from the silo 12, such as with a modulating notched cylinder, a rotary air lock or other flow control device may be used. The fly ash is transported from the silo 12 though the flow control valve 13 to a mass flow metering device 14 via a material transport mechanism 16, such as a feed air slide. Desirably, the mass flow metering device 14 is an inertial flow meter and desirably uses a rotating wheel to measure the mass flow of the fly ash as it feeds from the silo 12. However, other known metering devices such as ones that take measurements based on the Coriolis effect or other metering devices may be used. In one desirable embodiment, the flow control valve 13 is responsive to or otherwise modulates based on the mass flow rate signal obtained from the mass flow metering device 14 to control the position of the valve and provide a substantially steady and consistent flow of fly ash from the silo 12.

As illustrated, a chemical feeding device 18 adds the chemical reagent to the fly ash as the fly ash enters the mass flow metering device 14. To make the chemical reagent conveniently available near the location of ash transfer, a reagent handling and transfer system 22 is provided to supply the chemical feeding device 18 with the reagent. In one embodiment, the reagent handling and transfer system 22 includes a reagent storage bin 24 and a material transfer conveyor such as screw conveyor 25. The storage bin 24 may be supplied with reagent from a storage drum (not shown) using a vacuum system (not shown) or other transfer means. The screw conveyor 25 transfers the chemical reagent from the storage bin 24 to the chemical feeding device 18. The chemical feeding device 18 delivers the chemical reagent at a selected addition rate with a transfer screw 30 as the fly ash enters the mass flow metering device 14.

The dry chemical reagent and the dry fly ash are then blended together, desirably by a rotating wheel 32 in the mass flow metering device 14. The dry ash and chemical reagent blend is then directed via a conveyor 34 to a blended product storage container or otherwise transferred into rail or truck tanker by a load out spout 36. The fly ash, thus treated with the chemical reagent, can then be used at work sites. When the treated fly ash is mixed with water in the high pH environment of a cementitious slurry, the chemical reagent oxidizes the ammonia and forms stable reaction products that do not dissipate into the air, thus reducing the ammonia gas evolution. Desirably, the chemical reagent does not oxidize the ammonia until the treated fly ash is mixed in the cementitious slurry at the work site.

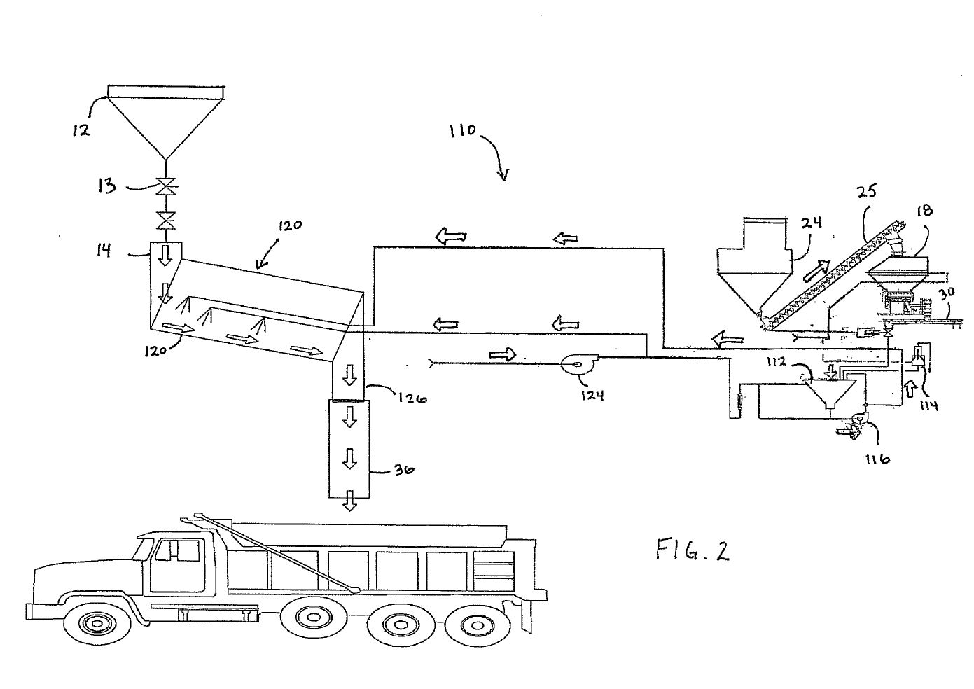

Turning now to FIG. 2, a wet treatment system 110 for blending the chemical reagent with ammonia-laden fly ash is schematically illustrated. It is contemplated that facilities processing fly ash will utilize at times both the dry treatment system 10 discussed above and the wet treatment system 110 depending to the properties of the fly ash and the intended use of the fly ash. Additionally, many components of the treatment systems 10, 110 have functions that overlap as will be clear to one skilled in the art and can suitably be used as part of either system. However, it also is contemplated that just the dry treatment system 10, or conversely, just the wet treatment system 110, may be needed in some circumstances and the invention is also directed to such use of only one of the described systems. The wet treatment system 110 is typically used with fly ash that is not sold into concrete applications but rather disposed in landfills or used in low value fill applications, such as mine and land reclamation. In these “disposal” and land application cases, the purpose for treating the ammonia-laden fly ash is to prevent the release of ammonia to the environment by leaching and/or to prevent human exposure to ammonia gas evolution from high pH ashes or those ashes processed with small amounts of cement to give them some cohesiveness and strength. For example, the ash may be conditioned with about 15% to 20% moisture to make it easy to handle in open trucks and land applications without excessive dusting. In sluicing, water is used to convey the ash to storage or disposal ponds and the water content could be as high as 95%.

The wet treatment system 110 follows similar concepts as the dry treatment system 10 described above for treating fly ash during transfer operations, except that the chemical reagent is not added in a dry state to dry fly ash, but is added to a portion of the water volume needed to condition or sluice the ash. A portion of the water used to condition the ash is added with the reagent to carry the reagent and help dispersing it the wet ash mix as will be explained below. The water used to deliver the reagent is desirably some fraction of the total water needed to condition or sluice the fly ash, such as between about 5% to about 20% of the total amount of water needed. However, other percentages of water may be used. The remaining amount of needed water for appropriate moisture content is then added to the fly ash. For example, in sluicing application, only a very small portion of the water would be used to carry the reagent into the sluice water system. When the reagent slurry comes in contact with the sluiced ash, the reagent oxidizes the dissolved ammonia in the sluice water.

As set forth above with respect to the dry system 10 of FIG. 1, the wet treatment system 110 illustrated in FIG. 2 contains a silo 12 and a flow control device 13 controlling the gravity discharge of the fly ash from the silo 12 to the mass flow metering device 14. Additionally, the same chemical feeding device 18 can also be used to add the chemical reagent. However, with the wet treatment system 110, the chemical feeding device 18 delivers the dry reagent into a wet slurry mixing cone 112. The chemical reagent is dissolved or made into slurry in water using the chemical feeding device 18 to meter the dry reagent at a selected rate and an eductor 114 to suspend or dissolve reagent in water in the mixing cone 114. The dissolved reagent or slurry is then transferred with a slurry pump 116 to a wet ash conditioning system 120.

The chemical reagent slurry is introduced to the ash as needed in a mixer (e.g., a pugmill, wet unloader, etc.) or a conveyance line 122 in the wet ash conditioning system 120. The remaining amount of needed water for appropriate moisture content is added in the mixer 122 using water booster pump 124. The treated wet ash is then sluiced or transfer using a conveyor 126 and discharged into the disposal or utilization site or suitable truck or rail vehicle as required. In the illustrated embodiment, the chemical solution or slurry is delivered and blended with the ash slurry to treat ammonia in the slurry transport lines and in the receiving impoundments. The ammonia in the fly ash is desirably substantially destroyed to prevent ammonia release to the environment from ash handling and disposal operations. Depending on the pH, chemical dosage and moisture content, the reaction could be complete in about 10 to 30 minutes.

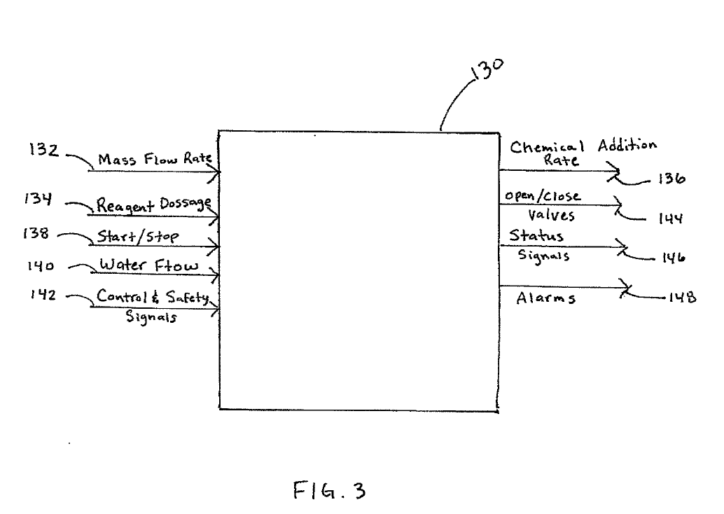

Referring now to both FIGS. 1 and 2, according to the invention the dry ash treatment system 10 and/or the wet ash treatment system 110 monitors the mass flow of the fly ash and adjusts the chemical reagent addition rate as necessary to produce the desired level of treatment. In one embodiment, the mass flow metering device 14 produces a signal corresponding to the mass flow rate of the fly ash being removed from the silo 12. For example, in one embodiment the mass flow metering device 14 measures the mass flow rate in tons of fly ash/minute and generates a signal corresponding to this mass flow rate. Referring now to FIG. 3, the mass flow rate signal 132 generated by the mass flow metering device 14 is sent to a programmed logic controller (PLC) 130. The PLC 130 uses the mass flow rate signal 132 and a desired reagent dosage 134 (e.g., lb reagent/ton of ash) as keyed in by the operator to determine a reagent addition rate. The PLC 130 then sends a signal corresponding to the chemical addition rate 136 to the chemical feeding device 18 which causes the chemical feeding device 18 to deliver the appropriate amount of reagent (e.g., lb reagent/min). Desirably, the system 10 performs this process continuously (i.e., many times per second) to accurately provide the desired amount of chemical reagent to the fly ash.

The PLC 130 is also used to control overall operation of the system 10. For example, in addition to the operator input for desired chemical reagent dosage 134 and ash mass flow rate 132 from the mass flow metering device 14, the PLC 130 desirably receives the following inputs: a) start/stop system signal 138; b) water flow/pressure signal 140 for the wet system 110; and c) various process control and safety signals 142 (reagent inventory hi/lo, reagent temp, transfer system vacuum, etc.). Outputs of the PLC 130 in addition to the chemical reagent addition rate 136 can include: a) open/close valves (i.e., flow control valve 13, valves in the water system) to start and stop the system 144; b) various operating status and reporting signals 146; and c) various alarms 148 (e.g., low reagent inventory, high reagent temp, loss of water flow/pressure, interruptions in ash feed, reagent feed, etc.).

The process for treating the fly ash in the systems 10, 110 will now be discussed. The fly ash is removed from the fly ash storage silo 12 by gravity discharge. The mass flow rate of the fly ash is metered with the mass flow metering device 14 to produce the mass flow rate signal 132. The mass flow rate signal 132 is used to control the flow control device to produce a substantially uniform flow rate of ash from the silo 12. The mass flow rate signal 132 is also used to determine the desired chemical addition rate 136 that is used by the chemical feeding device 18 to cause the reagent to be added to the fly ash at the proper rate to produce the desired reagent dosage 134. The PLC 130 continuously monitors the mass flow rate signal so that the proper chemical addition rate is maintained. The chemical reagent is then mixed or blended with the fly ash so that it is substantially uniformly dispersed in the fly ash. The chemical reagent can be added in the dry state as with the dry treatment system 10 or as a slurry or dissolved in water as with the wet treatment system 110. The treated ash is then transferred to a work or disposal location.

In the embodiments described above, a molar dosage of Cl:N between about 0.25:1 and about 3:1, preferably between 1:1 and 2:1, and most preferably 1.5:1, is desired to reduce ammonia and prevent ammonia gas evolution from cementitious mixtures containing ammonium compounds. For example, using 1:1 molar ratio, the theoretical amount, in kilograms (kg), of Ca(OCl)₂ per ton of ash needed to oxidize 100 mg/kg, as N ammonia to monochloramnine, is 0.51 kg. In the case of lithium hypochlorite (LiOCl), and using 1:1 molar ratio, the theoretical amount, in kg, of LiOCl per ton of ash needed to oxidize 100 mg/kg, as N ammonia to monochloramine, is 0.42 kg. As used herein, the phrase hypochlorite containing oxidizer is used to denote compounds that include the hypochlorite moiety or form such moiety upon addition of water. For example, the trichor compound forms hypochlorous acid and cyanuric acid upon water addition. At elevated pHs, the hypochlorous acid ionizes to the hypochlorite ion.

Desirably, the concentration of ammonia in the ammonia-laden fly ash is determined as part of the process. The concentration of ammonia in the fly ash is used to determine the desired reagent dosage 134 that is inputted to the PLC 130. In one embodiment, the concentration of ammonia can be determined using a rapid screening test procedure. The rapid screening test procedure requires obtaining a representative sample of fly ash. A predetermined amount of fly ash is mixed with a known volume of water in a closed beaker to dissolve the ammonium salts. The pH of the fly ash and water slurry is raised using sodium hydroxide to over 12.0 to convert ammonium cations (NH₄⁺) to ammonia gas (NH₃). The ammonia gas concentration in the closed headspace of the flask is measured using disposable ammonia gas detector tubes. A sample of the headspace gas is extracted through the detector tube using a handheld air sample extraction pump. The ammonia gas concentration in the beaker headspace is determined by the color change, usually yellow to blue, on the graduated detector tube. The ammonia gas concentration measured by the detector tube is directly related to the concentration of ammonia in the ash placed in the beaker. However, any method of determining the concentration of ammonia in the ammonia-laden fly ash may be used without departing from the scope of the invention.

This invention eliminates the need for expensive and multi step components by using a continuous weighing/blending device with an integrated reagent feeder monitored and operated using the programmable logic controller.

The above presents a description of the best mode of carrying out the present invention and of the manner and process of making and using the same. This invention is, however, susceptible to modifications and alternate constructions from that discussed above which are fully equivalent. Consequently, it is not the intention to limit this invention to the particular embodiment disclosed herein. On the contrary, the intention is to cover all modifications and alternate constructions coming within the spirit and scope of the invention as generally expressed by the following claims, which particularly point out and distinctly claim the subject matter of the invention.

What is claimed is:

1. A method for treating fly ash by addition of a chemical reagent during fly ash transfer operations, the method comprising:
discharging fly ash from a fly ash storage silo;
metering the mass flow rate of the fly ash being discharged with a mass flow metering device;
generating a signal from the mass flow metering device corresponding to the mass flow rate of the fly ash;
adding a chemical reagent to the fly ash at a selected chemical reagent addition rate with a chemical feeding device, wherein the chemical reagent addition rate is selected based upon the mass flow rate of fly ash removal;
blending the chemical reagent with the fly ash to treat the fly ash; and
transferring the treated fly ash to a work or disposal location.

2. The method for treating fly ash of claim 1 wherein the fly ash is discharged from the silo by controlled gravity discharge.

3. The method for treating fly ash of claim 2 wherein the gravity discharge of the fly ash is controlled using a flow control device.

4. The method for treating fly ash of claim 3 wherein the mass flow rate of the fly ash is metered using an inertial flow meter.

5. The method for treating fly ash of claim 4 wherein a rotating wheel in the inertial flow meter is used to blend and disperse the reagent in the fly ash.

6. The method for treating fly ash of claim 1 wherein the steps of adding the chemical reagent to the fly ash at a selected chemical reagent addition rate is controlled using a programmable logic controller (PLC).

7. The method for treating fly ash of claim 1 wherein the chemical reagent is an oxidizer to mitigate the effects of ammonia in the fly ash, wherein ammonia in ash is destroyed to prevent ammonia release to the environment from ash handling and disposal operations.

8. The method for treating fly ash of claim 7 wherein the signal from the metering device is used to determine the chemical reagent addition rate based on a pre-determined dosage, wherein the pre-determined dosage is selected by determining the concentration of ammonia in the fly ash.

9. The method for treating fly ash of claim 1 wherein the fly ash is used as a carrier for any dry or liquid reagent to impart a specific performance attribute in the final product using fly ash.

10. The method for treating fly ash of claim 1 wherein the fly ash is transferred by sluicing said ash for disposal or land based utilization using a water slurry containing the chemical reagent or a water solution containing the dissolved chemical reagent.

11. The method for treating fly ash of claim 10 wherein the chemical reagent is dissolved or made into slurry in water using a chemical feeding device and an eductor.

12. The method for treating fly ash of claim 11 wherein the chemical solution or slurry is delivered to a pugmill for spraying onto water conditioned fly ash.

13. The method for treating fly ash of claim 12 wherein the chemical solution or slurry is delivered and blended with the ash slurry to treat ammonia in the slurry transport lines and in the receiving impoundments.

14. A system for treating fly ash by addition of a chemical reagent during fly ash transfer operations, the system comprising:
a fly ash storage silo;
a mass flow metering device for metering the mass flow rate of the fly ash being discharged from the silo, wherein the metering device generates a signal corresponding to the mass flow rate of the fly ash;
a chemical feeding device for adding a chemical reagent to the fly ash at a selected chemical reagent addition rate;
a programmable logic controller configured to receive the signal corresponding to the mass flow rate of the fly ash and select the chemical reagent addition rate based upon said signal; and
a load out spout for delivering the treated fly ash.

15. The system for treating fly ash of claim 14 wherein the fly ash is discharged from the silo by controlled gravity discharge.

16. The system for treating fly ash of claim 15 further comprising a flow control device for controlling the gravity discharge rate of the fly ash.

17. The system for treating fly ash of claim 16 wherein the mass flow metering device is an inertial flow meter having a rotating wheel used to blend and disperse the reagent in the fly ash.

18. The system for treating fly ash of claim 17 wherein the chemical reagent is an oxidizer to mitigate the effects of ammonia in the fly ash, wherein ammonia in ash is destroyed to prevent ammonia release to the environment from ash handling and disposal operations and wherein the signal from the metering device is used to determine the chemical reagent addition rate based on a pre-determined dosage, wherein the pre-determined dosage is selected by determining the concentration of ammonia in the fly ash.

19. The method for treating fly ash of claim 18 further comprising a wet mixing cone configured to receive the chemical reagent from the chemical feeding device, wherein the chemical reagent is dissolved or made into slurry in water using a chemical feeding device and an eductor.

20. The system for treating fly ash of claim 19 wherein the chemical solution or slurry is delivered to a pugmill for spraying onto water conditioned fly ash.
